(19) United States
(12) Patent Application Publication
(10) Pub. No.: US 2006/0012874 A1
(43) Pub. Date: Jan. 19, 2006

(54) Raster scanning light microscope with punctiform light source distribution and applications

(76) Inventors: Joerg-Michael Funk, Jena (DE); Ralf Wolleschensky, Apolda (DE); Bernhard Zimmermann, Jena (DE); Stefan Wilhelm, Jena (DE); Ralf Engelmann, Jena (DE)

Correspondence Address: JACOBSON HOLMAN PLLC, 400 SEVENTH STREET N.W., SUITE 600, WASHINGTON, DC, 20004, US

(21) Appl. No.: 10/967,324

(22) Filed: Oct. 19, 2004

(30) Foreign Application Priority Data
Jul. 16, 2004 (DE) 10 2004 034 959.2

(51) Int. Cl. G02B 21/06

(52) U.S. Cl. 359/388; 359/385

(57) ABSTRACT

Raster Scanning Light Microscope with punctiform light source distribution with at least one illumination module, in which the means to achieve a variable partition of the laser light into least two illumination channels are envisioned and joint illumination of a sample takes place at the same or at different areas of the sample.

### DESCRIPTION OF THE OPERATION AND ADVANTAGES OF THE INVENTION

Use of two or more scan modules, in accordance with this invention, is especially sensible for the following method combinations (all the cited experiments would clearly benefit from a combined system with a shared laser module, as cost, the ability to obtain reproducible results, and flexibility are all clearly optimized by comparison to single systems):
1. Method combination imaging <-> fast scanning (e.g. a high resolution point scanner and a faster disk scanner)
   Egner et. al., J. Microsc. 2002, 206: 24-32 compare the efficiency and resolution of spinning-disk and multifocal multiphoton microscopes; depending on the specimen preparation, both systems would be useful.

Stephens and Allan, Science 2003, 300: 82-86 illustrate the advantages of different types of light- and confocal microscopy technologies for live cell imaging; despite the existence of various detection methods, most high-quality systems employ a single laser as the light source.
2. Method combination imaging <-> manipulation (e.g. coupling in of UV for uncaging/NLO)

Knight et al., Am. J. Physiol. Cell Physiol. 2003, 284: C1083-1089 describe Ca2+ imaging involving light activation via a laser; the laser could also be used for imaging. Denk., J. Nuerisc. Methods 1997, 72: 39-42 describe the use of pulsed mercury vapor lamps for in the release of pharmaceuticals; if a laser were used in this case, positionability and efficiency would be noticeably improved. Wang and Augustine, Neuron, 1995, 15: 755-760 describe fast Ca2+ Imaging involving localized release of pharmaceuticals via laser light; the laser could also be used for imaging.

3. Method combination imaging <-> FCS spectroscopy (Using the same VIS laser) Quing et al., Appl. Opt. 2003, 42: 2987-2994 describe bacterial experiments with FCS in water; both the imaging and the FCS components could make use of the laser. Bigelow et al., Opt. Lett. 2003, 28: 695-697 describe the examination of tumor cells with confocal fluorescence spectroscopy and fluorescence anisotropy; both the imaging and the spectroscopy components could make use of the laser.

4. Parallel imaging on more than one microscope array (Using the same pulsed NIR laser)

McLellan et al., J. Neurosc. 2003, 23: 2212-2217 describe the use of in-vivo multiphoton microscopy to depict amyloidal plaques in Alzheimer animal models; the microscope arrays are customized for the animal models; using multiple arrays with a shared laser would increase the throughput considerably. Zipfel et al., Proc. Natl. Acad. Sci USA 2003, 100: 7075-7080 describe the investigation of autofluorescence in living tissue using multiphoton and SHG microscopy; due to customizations the microscope array is not very universal; use of a second array would increase the flexibility.

5. Combination confocal and TIRF-microscopy Pollard and Apps, Ann. N.Y. Acad. Sci. 2002, 971: 617-619 describe new technologies for the examination of exocytose and ion transport using TIRF microscopy; the imaging laser could also be used for TIRF excitation. Ruckstuhl and Seeger, Appl. Opt. 2003, 42: 3277-3283 describe confocal and spectroscopic experiments upon nanoparticles and molecules using an innovative mirror objective during TIRF microscopy; due to the customized optics the array is not very universal; a second imaging array would increase flexibility.

Tsuboi et. al., Biophys. J. 2002, 83: 172-183 describe the study of endocrine cells with laser microforce- and TIRF microscopy; the imaging laser could also be used for TIRF excitation. In the given context, it is preferential or even absolutely necessary, respectively, to design the beam path of the laser module so that it is possible to achieve an infinitely variable partition of the beam among the illumination modules used. The use of a single laser module makes practical sense in that it reduces the amount of money spent on equipment, and thus effectively reduces costs.

The goal of the adjustable beam split design form is to guide individual wavelengths or wavelength ranges of the light source into different beam paths without influencing the remaining wavelengths, while simultaneously isolating the individual line selections and beam attenuation. This can occur in several ways:
1. Splitting of a light source into at least two separate beam paths by an optical element, during which the beam split ratio at optical element can be infinitely varied so as to flexibly accommodate the applicable operating requirements; whereby both beam paths would have to functionally support one of the method combinations 1-4, or alternatively, one beam is guided into a light trap into order to adjust the available laser strength to suit the applicable operating requirements.
   a. with at least one fiber coupling
   b. with at least one AOTF for laser line-selective beam attenuation
2-Splitting of a light source into two separate beam paths, in which splitting of the light source is accomplished using a polarizing beam splitter and a rotating lambda/2 plate or other element placed in front of it which allows for rotation of the polarization individually for each laser (e.g. liquid crystal, Pockels cell, Farraday rotator . . . ). As a result of what is in essence the infinitely variable orientation of the E-vector achieved via the lamba/2 plate (in some cases individually for each laser), the beam split ratio at the polarized beam splitter can essentially be infinitely varied for each laser, thereby enabling flexible accommodation to the applicable operating requirements.
   a. with at least one fiber coupling
   b. with at least one AOTF for laser line-selective beam attenuation
3. Splitting of a light source into two separate beam paths, in which the beam is split by a single or multiple dichroic beam splitters, whose reflection and/or transmission characteristics can be altered through manual or motor-assisted tilting.
   Altering the angle (e.g. from 45° to 50°) intended to be used with a specific sample plane leads to a change in the spectral characteristics, because the path lengths within the plane system change accordingly (corresponding in principle to the Fabry Perot Inferometer). This in turn allows the shift range of constructive and/or destructive interference to be variably adjusted, thereby allowing the beam split ratio to be flexibly suited to the applicable operating requirements.
a. with at least one fiber coupling
b. with at least one AOTF for laser line-selective beam attenuation
4. Splitting of a light source into two separate beam paths, in which the beam split is accomplished by a single acoustooptical or other single diffractive element, and in which the efficiency of diffraction in a (+) or (−) order of magnitude in relation to the zeroed order of magnitude must be variably adjustable, thereby allowing the beam split ratio between the first order of magnitude and (+) or (−) first order of magnitude to be flexibly suited to the applicable operating requirements.
   a. with at least one fiber coupling
   b. with at least one AOTF for laser line-selective beam attenuation
5. Splitting of a light source into two separate beam paths, in which a fast switchable mirror splits the beam. The switching frequency lie within the range of the image acquisition rate. Additionally, in order to influence the energy transported within the individual beam paths, a fast switchable beam attenuator, synchronized to the switching frequency for each laser, must be integrated via a liquid crystal filter.
6. Same as five, but the beam attenuation placed after the laser is accomplished by an acoustooptic or other diffractive component.

The advantage of variations 1-4 is that no parts need be moved during switching between the beam paths, which preserves the full dynamic performance capability of the array.

### DESCRIPTION WITH REFERENCE TO THE ILLUSTRATIONS

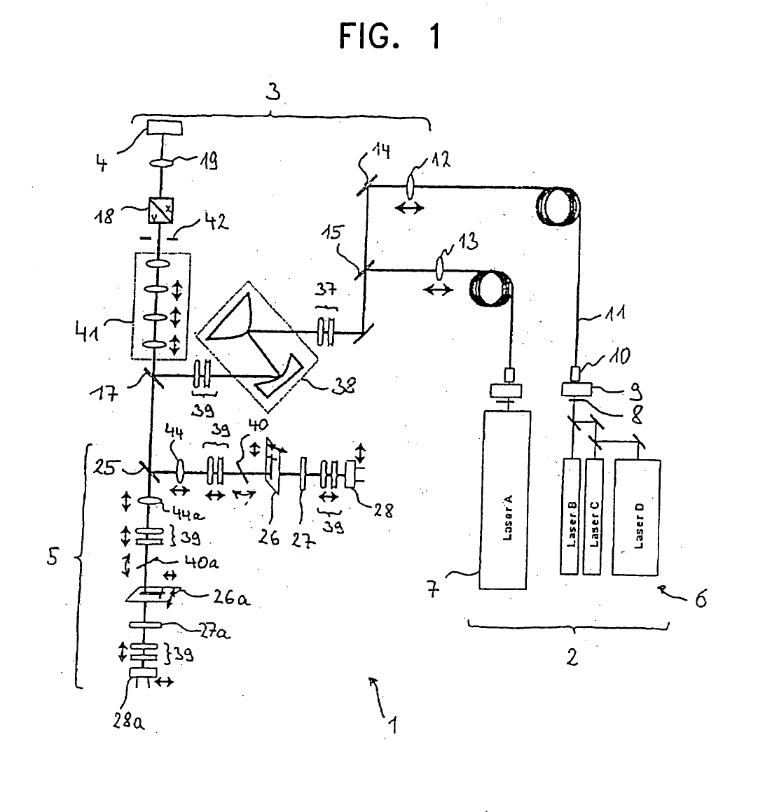

The following section describes an RT (real time) scanner with line scanning capability in greater detail, with reference to the drawings in FIG. 1-4.

FIG. 1 shows a laser scanning microscope 1, that is essentially constructed of five components: a radiation source module 2, which generates excitation radiation for the laser scanning microscope; a scan module 3, which conditions the excitation radiation and guides it into the proper position for scanning over a sample; a microscope module 4—only shown schematically for simplification—which aims the microscopic beam of scanning radiation prepared by the scanning module at a sample; and detector module 5, which receives and detects optical radiation from the sample. The design of detector module 5 can be spectrally multi-channeled, as illustrated in FIG. 1.

For a general description of a punctiform scan laser scanning microscope, reference is made to DE 19702753A1, which description has been fully integrated into the current description. The radiation source module 2 generates illuminating radiation appropriate to a laser scanning microscope, or more specifically, radiation which can induce fluorescence. Depending on the application in use, the radiation source module has a number of respective radiation sources available for it. In one illustrated design variation, two lasers 6 and 7 are envisioned in radiation source module 2, after each of which a light valve 8 and beam attenuator 9 are connected, and both of which couple their radiation into a lead optical fiber 11 at coupling point 10. The light valve 8 functions as a beam deflector and allows a beam shutdown to be effected without necessitating an actual shutoff of the lasers themselves in laser units 6 and/or 7. Light valve 8 is designed as an AOTF, for example, and effectively causes a beam shutdown by deflecting the laser beam into an undiagrammed light trap before it is can couple into the lead optic fiber 11.

In the example illustration in FIG. 1, laser unit 6 is shown containing three lasers, B, C, D whereas laser unit 7 contains only one laser A. The illustration is therefore a good example of a combination of single- and multiwavelength lasers, which are coupled individually or also together into one or more fibers. The coupling can also occur simultaneously at multiple fibers, and their radiation combined later using color combiners after passing through an adaptable lens. This makes it possible to use the most widely varying wavelengths or wave ranges for the excitation radiation.

Using moveable collimation lenses 12 and 13, the radiation coupled into lead optic fiber 11 is guided together via beam combining mirrors 14, 15 and its beam profile subsequently transformed within a beam formation assembly.

Collimators 12 and 13 ensure that the radiation passing from radiation source module 2 to scan module 3 is collimated into an infinite beam path. In each case, respectively, this is best accomplished by a single lens, which assumes a focusing function by virtue of its being moved along the optical axis under the direction of a central control unit (not shown) and rendering adjustable the distance between collimators 12, 13 and the respective ends of the lead optic fibers.

The beam formation assembly, which will be explained in detail at a later point, generates a line-shaped beam from the rotationally symmetric, Gaussian-profiled laser beam, its form after encountering beam combining mirrors 14, 15. The resulting beam is no longer rotationally symmetric, and its cross-section is suitable for generating a rectangular illuminated field.

This illumination beam, alternatively described as line-shaped, acts as excitation radiation and is guided to scanner 18 via a main color splitter 17 and a zoom lens which has yet to be described. The main color splitter will also be detailed at a later point, here it is only noted that it functions to separate the sample radiation returning from microscope module 4 from the excitation radiation.

Scanner 18 guides the line-shaped beam on one or two axes, after which it is condensed onto a focus point 22 through a scan objective 19 as well as a tube lens and an additional lens within microscope module 4. This focus point is located within a slide preparation and/or sample. The sample is illuminated with excitation radiation in a focal line, through which process optical imaging occurs.

The fluorescence radiation, excited in a line-shaped focus in this manner, travels via an objective, a tube lens belonging to microscope module 4 and scan objective 19 back to scanner 18, so that in reverse direction after scanner 18, a dormant beam exists. For this reason, in this connection it is said that scanner 18 “descans” the fluorescence radiation.

The main color splitter 17 allows fluorescence radiation to pass through as it occupies a different wavelength range than the excitation radiation. This enables it to be redirected into detector module 5 via a deflection mirror 24 and subsequently analyzed. In the design variation in FIG. 1, the detector module 5 is depicted with several spectral channels, i.e. the fluorescence radiation from deflection mirror 24 is split into two spectral channels within a secondary color splitter 25.

Each spectral channel is equipped with a slot diaphragm 26, which enables realization of a confocal or partially confocal image of the sample 23, and whose size determines the depth of field used to detect the fluorescence radiation. The geometry of the slot diaphragm 26 therefore determines the section plane in the (thick) slide preparation from which the fluorescence radiation will be detected.

In addition, a barrier filter 27 is placed after slot diaphragm 26 in order to block undesirable excitation radiation which has managed to enter detector module 5. The radiation isolated in this manner, originating from a specific section plane, line-shaped and fanned out, is then analyzed by a suitable detector 28. The second spectral detection channel is designed analogously to the color channel already described, likewise including a slot diaphragm 26a, a barrier filter 27a, and a detector 28a.

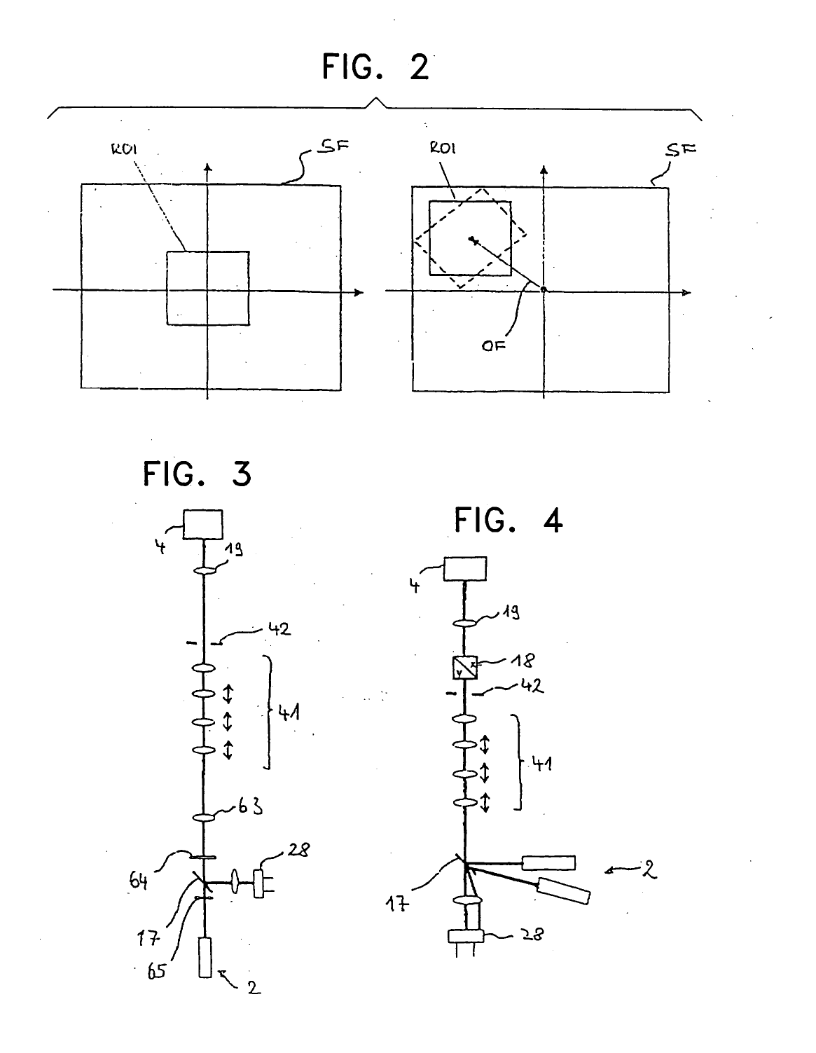

A confocal slot diaphragm is used in detector module 5 only for the sake of example. A single point scanner could naturally be used as well. The slot diaphragms 26, 26a are then replaced by hole diaphragms, and the beam formation assembly can be omitted. Finally, in this type of array all lenses are designed rotationally symmetric. In essence, this would naturally permit the use of any preferred type of multiple point scanning arrangement, such as point clouds or Nibkow disk concepts, could be used instead of single point scanning and detection. These types of arrays will be explained later with reference to FIGS. 3 and 4. It is, essential, however, that detector 28 is equipped with localized resolution, since parallel capture of multiple sample points occurs during the scanner sweep.

FIG. 1 shows how the beam accumulation, which is Gaussian-shaped after passing moveable, i.e. sliding collimators 12 and 13, is combined via a mirror progression consisting of beam combining mirrors 14, 16, and in the illustrated array containing a confocal slot diaphragm, is subsequently converted into a beam cluster with a rectangular beam cross-section. In the design form detailed in FIG. 1, a cylindrical telescope 37 is utilized in the beam formation assembly, with an aspherical unit placed after it, and cylindrical lens 39 after that.

Following transformation, at profile level the resulting beam essentially illuminates a rectangular field, in which the intensity distribution along the longitudinal field axis is not Gaussian-shaped, but box-shaped instead.

The illumination array containing aspherical unit 38 can essentially function to create an evenly filled pupil between tube lens and objective. In this manner, the optical resolution of the objective can be fully exploited. This variant is therefore well-suited to a single-point or multipoint scanning microscope system, also e.g. a line-scanning system (in the latter it is supplemental to the axis upon which focusing onto or into the sample is accomplished).

The line-shaped conditioned excitation radiation, by way of example, is guided to the main color splitter 17. This is depicted in its preferable design form as a spectrally-neutral splitting mirror in accordance with DE 10257237 A1, the published contents of which have been fully incorporated in the present description. The concept of “color splitter” therefore refers to splitting systems that operate non-spectrally. Instead of the spectrally independent color splitter described, a homogenous neutral splitter (e.g. 50/50, 70/30, 80/20 or other) or a dichroic splitter could be used. In order to ensure a range of choices with regard to potential applications, the main color splitter is preferably equipped with a mechanism that enables a simple change, for example through an appropriate beam splitting wheel containing single, interchangeable splitters.

A dichroic main color splitter is particularly useful in cases where coherent, in other words, directed radiation must be detected, e.g. reflection, Stokesian and/or anti Stokesian Raman spectroscopy, coherent Raman processes of a higher order of magnitude, general parametric non-linear optical processes, such as second harmonic generation, third harmonic generation, sum frequency generation, two- and multi-photon absorption and/or fluorescence. Several of these non-linear procedures from optical spectroscopy require the use of two or more laser beams collinearly layered upon one another. In this connection, the herein described beam combination of the radiation from several lasers is especially applicable. In general, dichroic beam splitters could have a wide variety of uses in fluorescence microscopy. In Raman microscopy, additional placement of holographic notch splitters or filters in front of the detectors in order to suppress whatever portion of Rayleigh stray radiation is present would be useful.

In the design form illustrated in FIG. 1, the excitation radiation/illumination radiation is directed to scanner 18 via a motor-controlled zoom lens 41. This allows the zoom factor to be adjusted accordingly and the scanned field of view to be continually variable within a specific adjustment range. A zoom lens offers particular advantages, as it maintains the pupil position in an ongoing process of fine-tuning during adjustment of the focal position and imaging scale. The motor degrees belonging to zoom lens 41—illustrated in FIG. 1 and symbolized by arrows—correspond exactly with the number of grades of freedom anticipated for adjustment of the three parameters: image scale, focus, and pupil position. Use of a zoom lens 41, to whose exit pupil a flap 42 is affixed, has distinct advantages. This variation can be realized simply and practically by mimicking the action of flap 42 through restriction of the reflective area of scanner 18. The exit-side flap 42, together with zoom lens 41, assures that a specific pupil diameter will always be imaged on scan objective 19, independent of adjustments of the zoom lens enlargement. Thus, during any type of adjustment to the zoom lens 41, the objective pupil remains fully illuminated. The use of an autonomous flap 42 effectively inhibits the appearance of undesirable stray radiation in the vicinity of scanner 18. The cylindrical telescope 37 works together with the zoom lens 41, which is also motorized and is placed in front of the aspherical unit. In the design form depicted in FIG. 2, this option was chosen to ensure a compact array, but it is not a requirement.

If a zoom factor smaller than 1.0 is desired, the cylindrical telescope 37 is automatically swung into the beam of optical radiation. When zoom lens 41 is shortened, this keeps the aperture filter 42 from being receiving inadequate illumination. The swinging cylindrical telescope 37 thus guarantees that also at zoom factors smaller than 1, i.e. independent of adjustments to zoom lens 41, an illumination line with a constant length is always present at the location of the objective pupil. This allows drops in laser performance within the illumination beam to be avoided, by comparison to a simple visual field zoom.

Because engagement of the cylindrical telescope 37 causes an abrupt and unavoidable jump in image brightness, the control unit is configured to appropriately adjust either the positioning rate of scanner 18 or an intensification factor of the detectors in detector module 5 upon engagement of the cylindrical telescope 37, in order to maintain a constant level of image brightness.

In addition to the motor-driven zoom lens 41 and the motor-activated cylindrical telescope 37, remote-controlled adjusting elements are also envisioned in detector module 5 of the laser scanning microscope. In order to compensate for chromatic difference of focus, for example, a circular lens 44 and a cylindrical lens 39 are envisioned in front of the slot diaphragm, in addition to a cylindrical lens 39 placed directly in front of detector 28, each of which, respectively, can be moved in an axial direction by a motor.

A correction assembly 40 is additionally envisioned for compensation purposes; a brief description follows.

Slot diaphragm 26, together with a circular lens 44 in front of it, the first cylindrical lens 39 also in front of it and the second cylindrical lens placed after it, forms a pinhole objective in detector arrangement 5, in which the pinhole is realized here by the slot diaphragm 26. In order to avoid undesirable detection of excitation radiation reflected inside the system, a further barrier filter 27 is connected in front of the second cylindrical lens 39. This filter possesses the spectral characteristics necessary to allow only the desired fluorescence radiation to reach detector 28, 28a.

Changing the color splitter 25 or the barrier filter 27 leads to a certain unavoidable amount of tilt or wedge error when these parts are re-engaged. The color splitter can create errors between the sample area and slot diaphragm 26, while barrier filter 27 can induce errors between slot diaphragm 26 and detector 28. In order to avoid the necessity of readjusting the position of slot diaphragm 26/detector 28, a parallel plane plate 40 is placed between circular lens 44 and slot diaphragm 26, i.e. within the imaging beam path between the sample and detector 28. The plate can be set to different tilt positions via instructions from by a control unit. To accomplish this, the plane-parallel plate 40 is adjustably attached using an appropriate mounting.

FIG. 2 displays how a region of interest can be selected within the maximum available scan field SF with the aid of zoom lens 41. If the scanner 18 controls are manipulated in such a way that the amplitude does not change, as is absolutely necessary in a resonance scanner, for example, a zoom lens enlargement adjustment of more than 1.0 causes a narrowing of the selected region of interest, centered on the optical axis of the scan field SF.

An example description of resonance scanners can be found in Pawley, Handbook of Biological Confocal Microscopy, Plenum Press, 1994, page 461 ff. If the scanner is directed to scan a specific field asymmetrically with respect to the optical axis—i.e. with respect to the resting position of the scanner mirror—an offset shift OF of the chosen region of interest is obtained in connection with the action of the zoom lens. Through the already-mentioned descanning action of scanner 18, as well as repeated passage through zoom lens 41, the selected region of interest within the detection beam path is canceled out as the beam travels back in the direction of the detector. This allows for selection of a very wide range of possible ROI areas within the sample. In addition, pictures can be taken of the different regions of interest selected, and these can then be combined into a high resolution image.

If one wishes to not only to shift the chosen region of interest not only one offset OF with relation to the optical axis, but to rotate it in addition, the applicable design form envisions placement of an Abbe-König prism in a pupil of the beam path between the main color splitter 17 and the sample 23, which is known to cause rotation of the image field. This also is canceled out in the reverse beam path moving in the direction of the detector. At this point, images with different offset shifts OF and different rotation angles can be acquired and finally combined in a high resolution image, through an algorithm, for example, as described in the publication, Gustafsson, M., “Doubling the lateral resolution of wide-field fluorescence microscopy using structured illumination,” in “Three-dimensional and multidimensional microscopy: Image acquisition processing VII,” Proceedings of SPIE, Vol. 3919 (2000), p. 141-150.

FIG. 3 illustrates another possible design form for a laser scanning microscope 1, in which a Nipkow disk approach is realized. Light source module 2, which is represented in highly simplified fashion in FIG. 3, illuminates a Nipkow disk 64 via a mini lens array 65 and then directly through the main color splitter 17, as described for example in U.S. 6,028,306, WO 88 07695 or DE 2360197 A1. The pinholes of the Nipkow disk, illuminated via the mini-lens array 65, are imaged onto the sample found in microscope module 4. In order that the size of the image acquired from the sample side can be varied here as well, zoom lens 41 is again envisioned.

In a departure from the design of FIG. 1, in the Nipkow scanner illumination occurs during passage through the main color splitter 17, and the radiation to be detected is separated off via a mirror. In a further departure from FIG. 2, detector 28 is now designed with localized resolution, in order that the multipoint illumination provided by the Nipkow disk 64 can be appropriately scanned in parallel fashion. Additionally, a suitable fixed lens 63 with positive refractive power is placed between the Nipkow disk 64 and the zoom lens 41, changing the radiation diverging from the pinholes in the Nipkow disk 64 into clusters of appropriate diameter. Within the Nipkow design in FIG. 3, the main color splitter 17 functions as a classical dichroic beam splitter, i.e. not as a beam splitter with a slit-shaped or point-shaped reflective area, as previously discussed.

Zoom lens 41 conforms to the design previously mentioned, although scanner 18 is naturally rendered unnecessary by the Nipkow disk 64. The scanner could be envisioned nonetheless should selection of a region of interest be undertaken in accordance with FIG. 2. This also holds true for the Abbe-König prism.

FIG. 4 schematically represents an alternative approach using multipoint scanning, in which multiple light sources stream into the scanner pupil in slanted fashion. Here as well, through use of zoom lens 41 for imaging between main color splitter 17 and scanner 18, a zoom function similar to that shown FIG. 2 can be achieved. By the simultaneous beaming of raylets at varying angles into a plane conjugated toward the pupil, light points are generated in a plane which is conjugated toward the object plane, and are simultaneously guided over a portion of the entire object field by scanner 18. The information needed for imaging is derived from evaluation of all the partial images on localized resolution matrix detector 28.

A multipoint scanning array which is described in U.S. 6,028,306 represents another possible design form. The published details of the above patent have been fully taken into account here. In this case as well, a detector 28 with localized resolution is envisioned. The sample is then illuminated by a multi-point light source, realized by means of a beam expander with a microlens array placed after it. The characteristics of the illumination of a multi-aperture plate which results are such that a multipoint light source can be said to be effectively realized. In the set of diagrams to follow, the following elements and terminology are depicted and used (reference is also made to the explanation in EP977069A1)
Lasers 1-4 and/or A-G as light sources
Deflection mirror US for deflection of the laser beam
Light flap or shutter V as light closure
rotating λ/2 plate
PT pole splitter for pole splitting
LF optic fibers for light transport
fiber coupling port for fiber coupling
attenuator A (AOTF or AOM preferred)
MD monitoring diode for radiation detection
PMT 1-3 detectors for wavelength-sensitive radiation detection
T-PMT detector for detection of transmitted radiation
Pinholes PH 1-4
DBS 1-3 color splitter
Pinhole lenses for focusing at the pinhole
MDB main color splitter
EF 1-3 emission filter
Collimators for wavelength-dependent adjustments
Scanner
Scan optical system or scan lens
Ocular
Tube lens
Beam combiner
Non-descanned detector between objective and scanner
Objective
Sample
Condenser
HBO white light source
HAL halogen lamp for throughput illumination
telescopic lens
zoom lens
beam formation apparatus for generation of an illumination line
cylindrical telescope
cylindrical lens
gap
detector for line capture with slot diaphragms
SS faster switching mirror

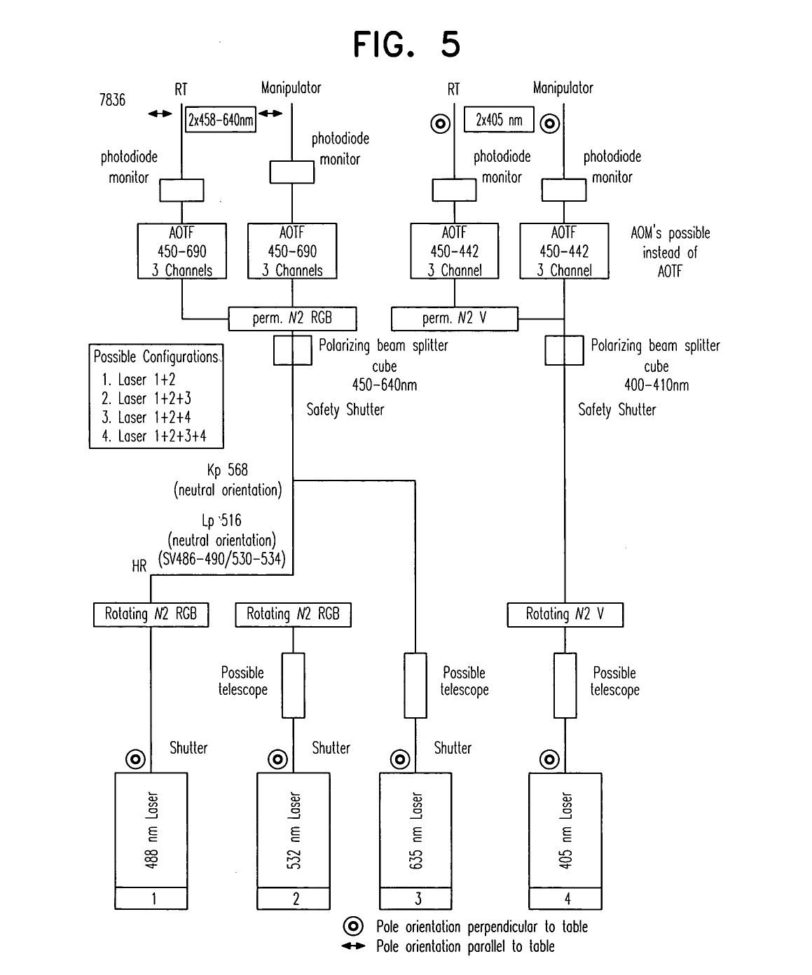

Four lasers 1-4 with varying wavelengths are represented in FIG. 5, in front of which are connected, in the direction of the light, a shutter and rotating λ/2 plates for establishing a specific polarization plane from the linearly polarized laser beam. Lasers 1-3 are combined via deflection mirrors and dichroic splitters, and arrive at the polarized beam splitter cube as does laser 4. Here, the dichroic splitters must be designed so that their transmission and/or reflection characteristics are independent of the rotation of the polarization plane. Depending on the respective orientation of their polarization planes, the laser beams are fully or only partially transmitted or reflected (laser 4 is not combined here with other lasers, but is instead guided directly to the pole splitter) and are guided in the direction of the optical fibers via selective beam attenuators (AOTF). One of the fixed λ/2 plates in the transmission (VIS)/reflection (V) light paths sets the correct polarization plane for the AOTF. Coupling ports for optical fibers are envisioned in different microscope arrays, and are described in further detail toward the end. The polarizing beam splitting cube has only two settings. Transmitted light is always polarized parallel to the mounting plate, while reflected light is always polarized perpendicular to the mounting plate. If the lambda/2 plate is located in front of a laser with its optical axis at an angle of less than 22.5° with respect to the laser polarization (linearly polarized and perpendicular to the mounting plate), the polarization plane is rotated 45°. In other words, the polarizing beam splitter functions as a 50/50 splitter. Different angles generate different split ratios, e.g. lambda/2 plate under 45° means a 90° rotation of the polarization plane and theoretically 100% reflection at the polarizing beam splitter cube. This further implies that the AOTF in the reflection path (at the pole splitter) always sees perpendicularly polarized light, ensuring that the AOTF is used correctly. For the transmission path, a permanent 90° rotation of the polarization plane is necessary in order to comply with the requirement that “AOTF entry polarization perpendicular to mounting plate”. Decoupling of the lambda/2 plates takes place through the polarization splitting cube. An RT scanning microscope and a scanning manipulator are given here by way of example, with which varying wavelengths can be divided in different ways.

This takes place infinitely through appropriate electronically coordinated rotation of the individual lamda/2 plates. This allows for a highly variable operating setup, and also one involving operation of multiple independent observation and/or manipulation systems.

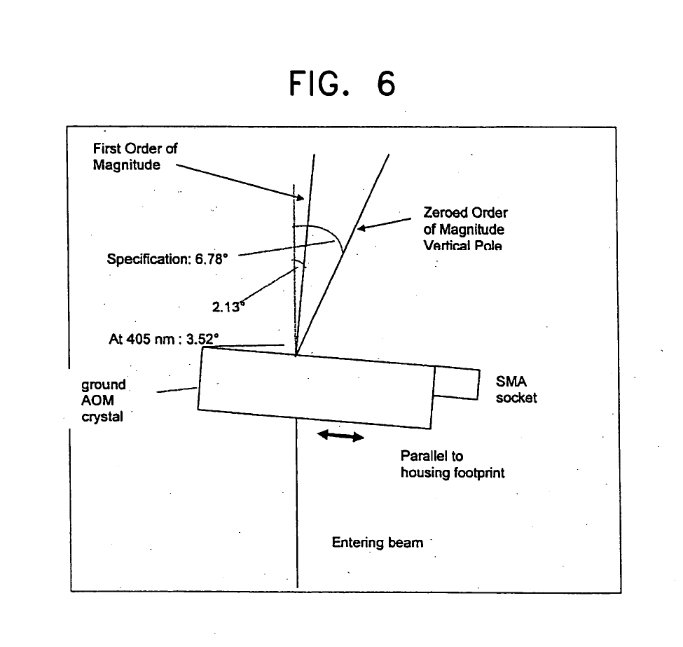

FIG. 6 is a schematic representation of an AOM crystal, which splits an entering beam—for example a laser beam with a 405 nm wavelength—into two linear beams of the zeroed and first orders or magnitude that are nonetheless polarized perpendicularly to each other, and that can be coupled into different beam paths. The ratio of the beam components can be altered by corresponding adjustments to the AOM.

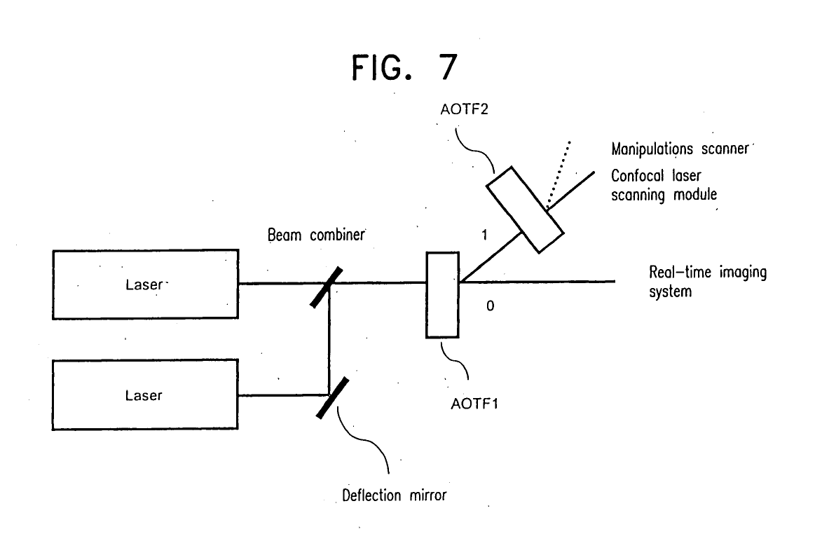

FIG. 7 illustrates two lasers that are combined via deflection mirrors and beam combiners, and following which an AOTF1 is connected for achieving an adjustable split of the beam into zeroed and first orders of magnitude.

The first diffracted order of magnitude of the AOTF, the actual working beam, is collinear for the entire defined spectral area (e.g. 450-700 nm). The zeroed order of magnitude is split by the prismatic effect of the crystal. This configuration is therefore only useful for a specific wavelength (must be specified). Configurations which might compensate for the splitting of the first order of magnitude (second prism with reversed dispersion, correspondingly modified AOTF crystal) are naturally conceivable.

The intensity within the branches of various orders of magnitude is adjustable depending on the wavelength; an applied control current regulates the diffracted intensity of the first order, the remainder stays in the zeroed order).

The beams of the zeroed and first orders can enter different observation and/or manipulation systems.

In single branch, here of the first order of magnitude, an additional AOTF2 could be envisioned, through which yet another splitting could be accomplished.

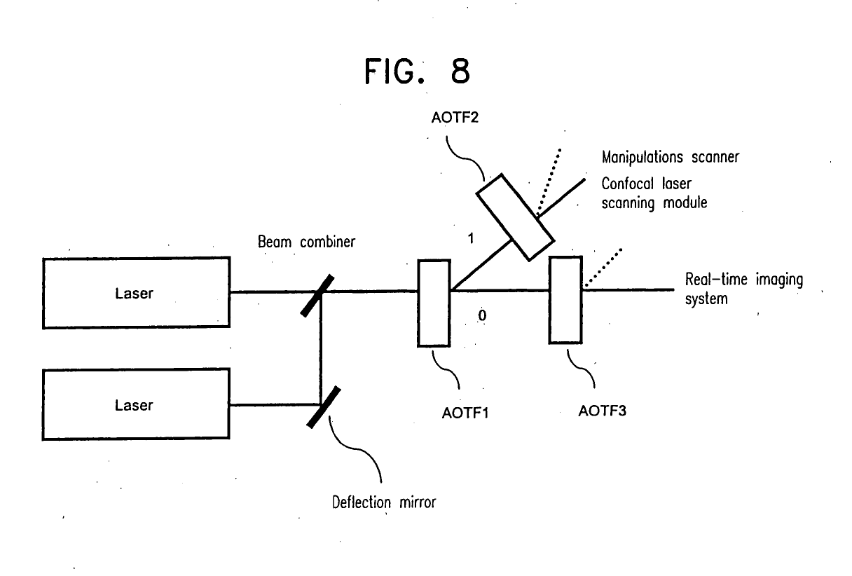

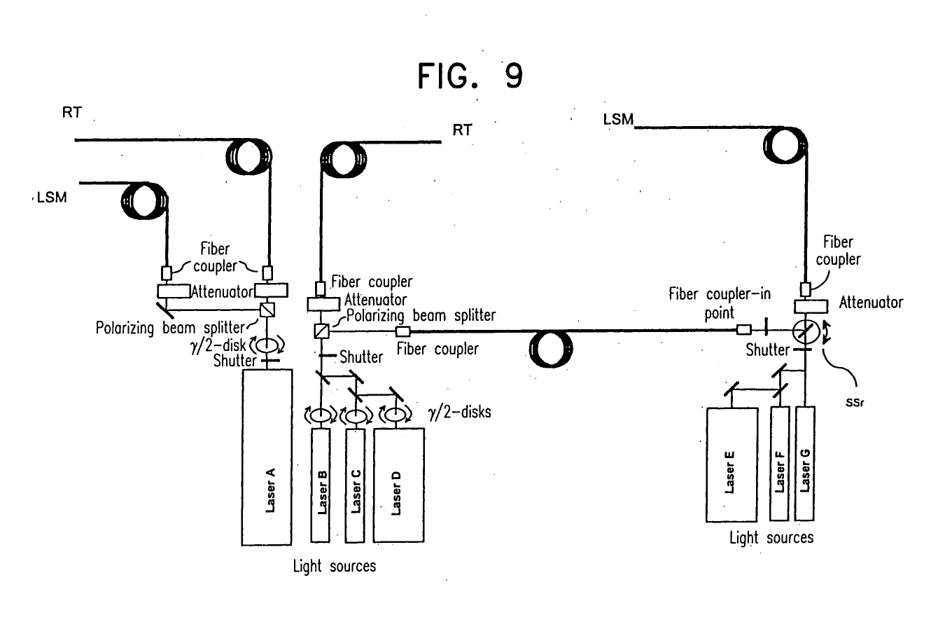

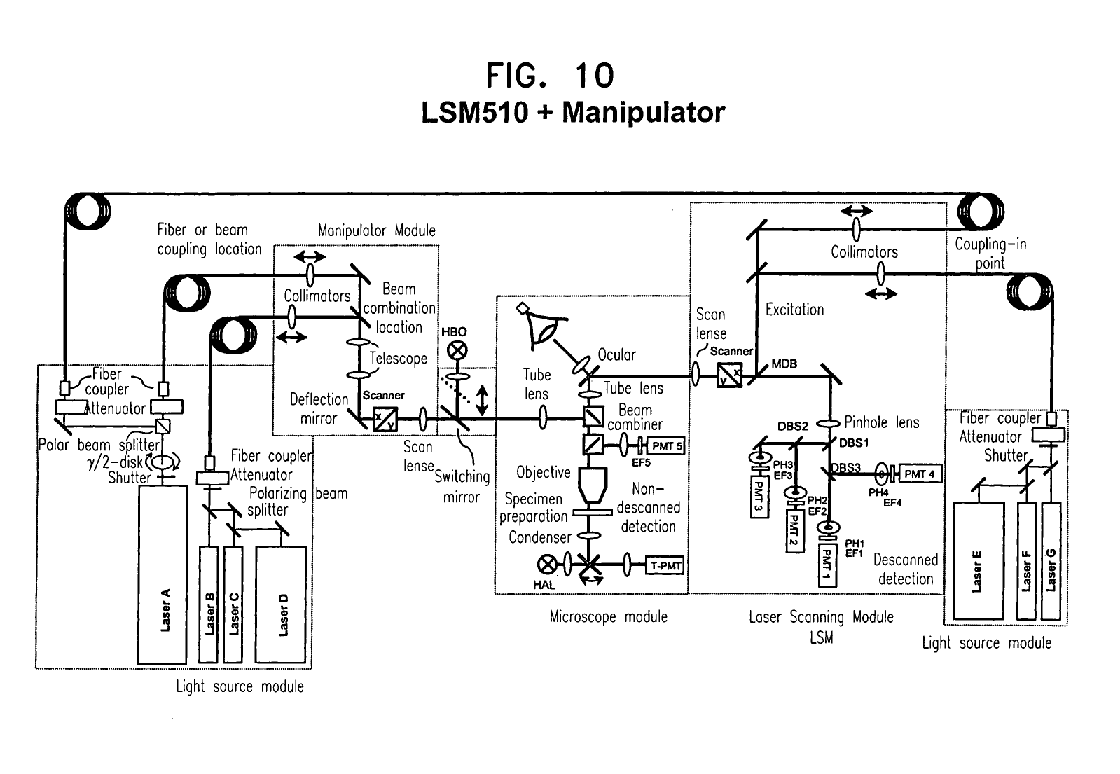

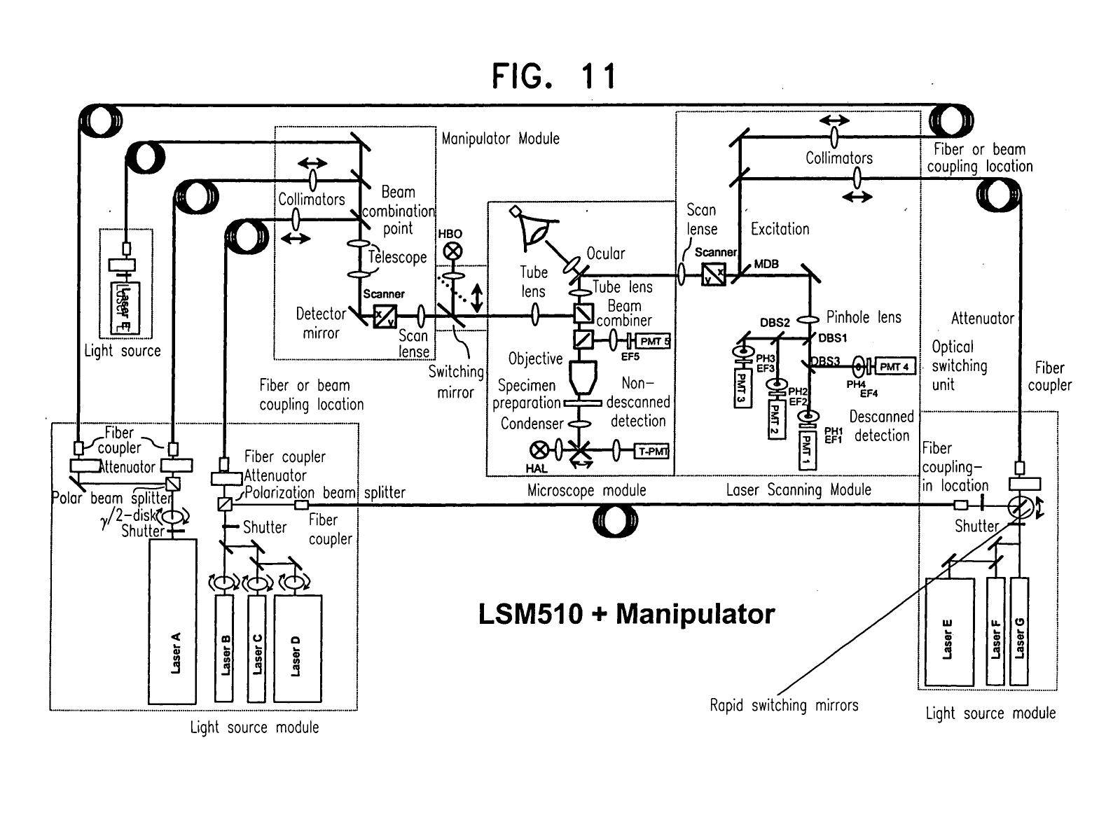

In a similar fashion, FIG. 8 shows an AOTF3 envisioned for the remaining branch (zeroed order of magnitude). If, for example, AOTF1 guides a wavelength of full intensity into this branch, a further split can be accomplished by using the AOTF3. FIG. 9 depicts an illumination component involving laser A, in which the light can be adjusted by a λ/2 plate positioned with reference to the orientation of the light's polarization plane, is then accordingly reflected or transmitted at the polarizing beam splitter cube, and finally enters different systems adjustably, for example an LSM510 and a line scanner, via the illustrated optical fibers. The light from the lasers B-D is condensed, as in FIG. 1, following respective adjustment of the light from each laser by means of λ/2 plates positioned in accordance with the orientation of each beam's respective polarization plane. The light is then reflected/transmitted, travels in each respective case through optical fibers and reaches either an RT line scanner or a further illumination module containing lasers E-G.

Coupling into the illumination beam path of lasers E-G takes place, for example, via a fast SS switchable mirror, which alternately enables opening up of or coupling into the beam path. The switchable mirror can also take the form of a wheel that alternatively exposes reflecting and transmitting sections.

A permanent beam splitter for effecting beam combination is equally plausible.

At this coupling point, light from lasers B-D can also adjustably combined with the light from lasers E-G, traveling via an optical fiber to an LSM 510, for example.

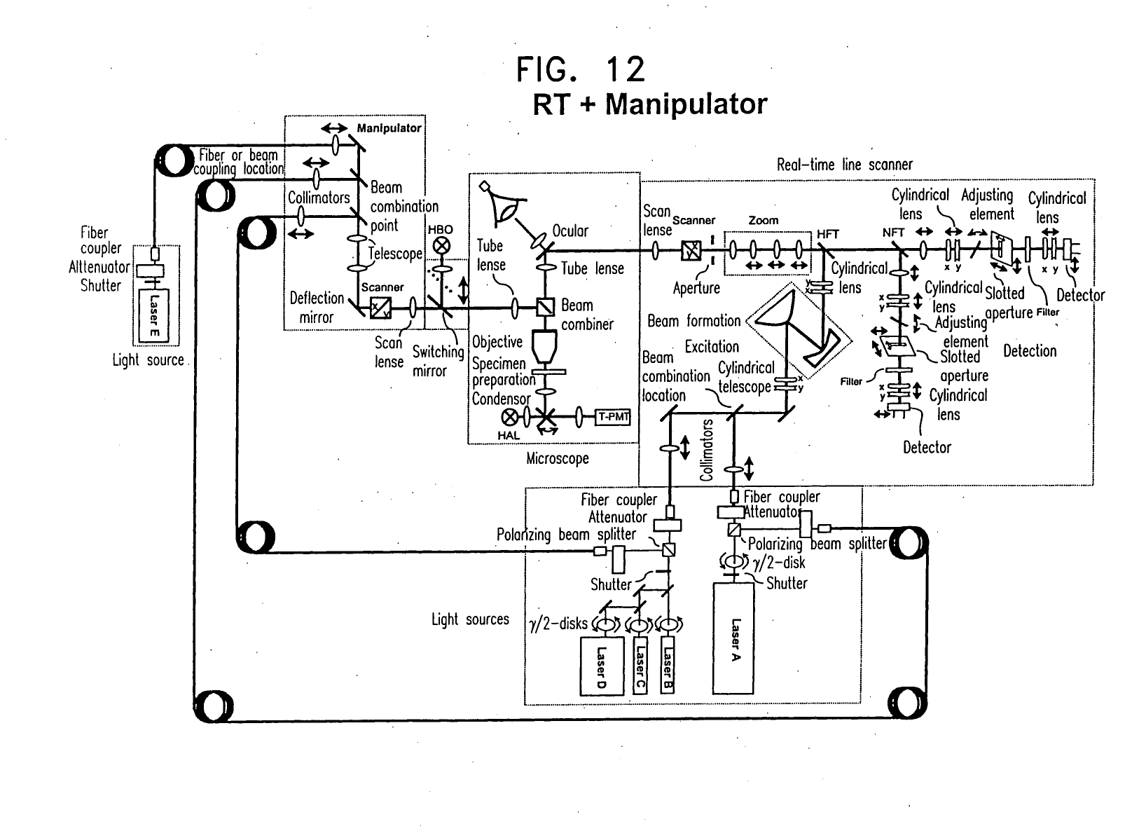

FIG. 10 envisions a laser scanning microscope with light sources E-G, a scan module (LSM) and a microscope module, as is described by way of example in DE.

A manipulation system, consisting of a light source module and a manipulator model, is coupled in by means of a beam combiner.

Via the manipulator scanner, specific areas of the sample could be subjected to targeted bleaching, for example, or physiological reactions induced, while image acquisition could occur in simultaneously or in alternating fashion using the LSM 510.

Within the light source module of the manipulator, a λ/2 plate is envisioned—placed after laser A for example—working together with a polarized beam splitter cube which adjustably partitions the light from laser A, as described above, into the manipulation beam path and the LSM 510 beam path, respectively, via optical fibers.

For this purpose, a separate coupling point is envisioned at the LSM, at which the various coupled beams are themselves coupled via (internal) mirrors and beam splitters.

In this way, laser A can be used by both systems.

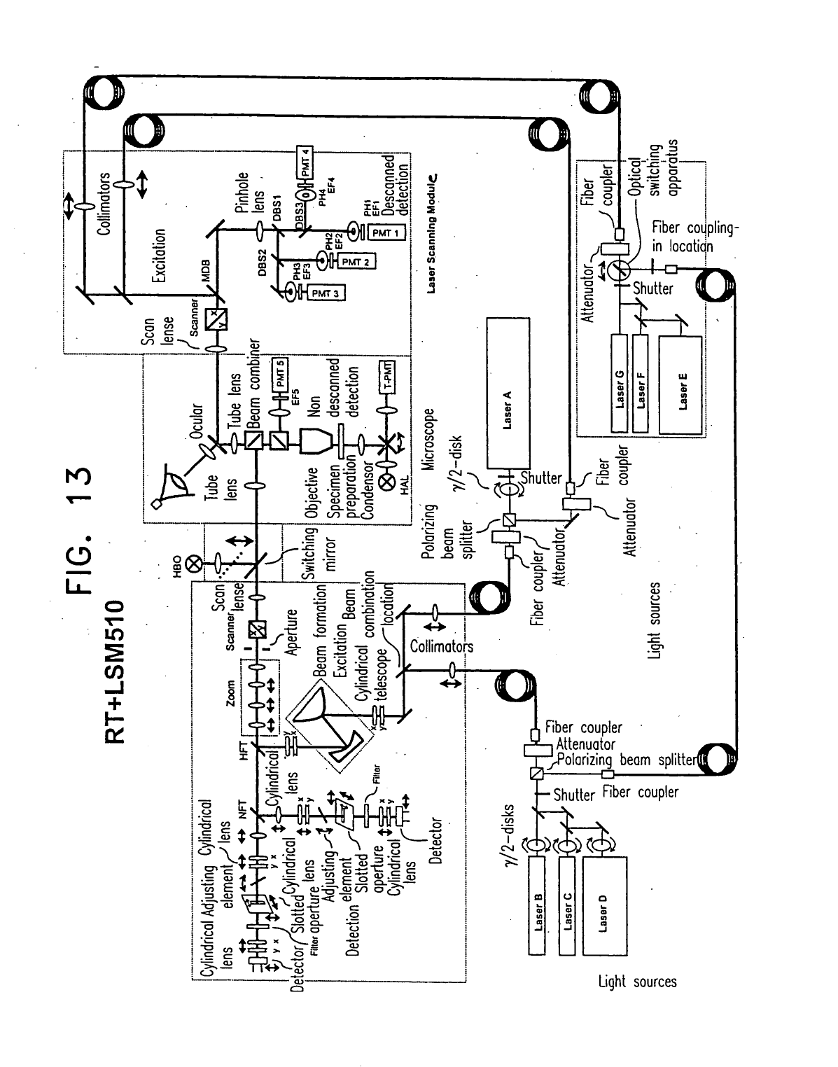

In FIG. 11, the ratios of lasers B-D in the manipulator are also adjustable via λ/2 plates and polarized beam splitter cubes, and an additional connection in the direction of the LSM exists at the pole splitter via an optical fiber, allowing the LSM to be coupled in by means of a fast switchable mirror (mirror flap), for example.

In this way, light from lasers B-G, in addition to the light from laser A, enters adjustably into both beam paths.

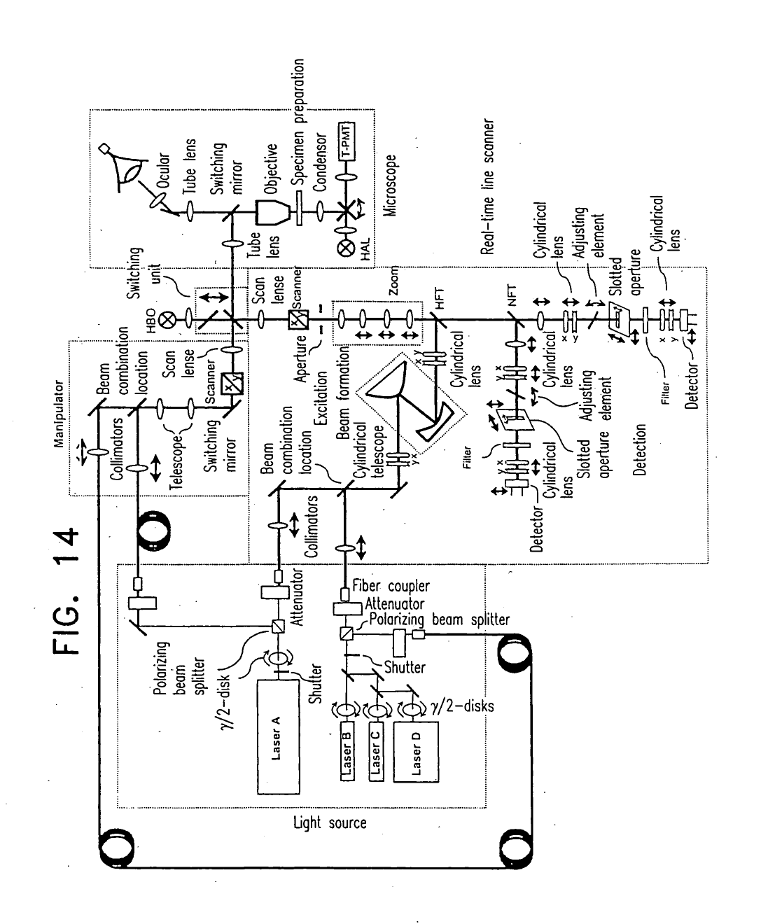

FIG. 12. envisions an RT line scanner in addition to the manipulator, which allows the light, via beam formers, to enter the microscope beam path in line shape.

Here, through use of λ/2 plates and pole splitters, a shared light source module is envisioned in which an adjustable allocation within the systems can again be accomplished.

Thus, light from lasers A-D is available to both systems, which would mean a considerable simplification and cost-savings.

An additional light source E could be envisioned as an option, by way of example, only for the manipulator, as its wavelengths are not required in the RT scanner.

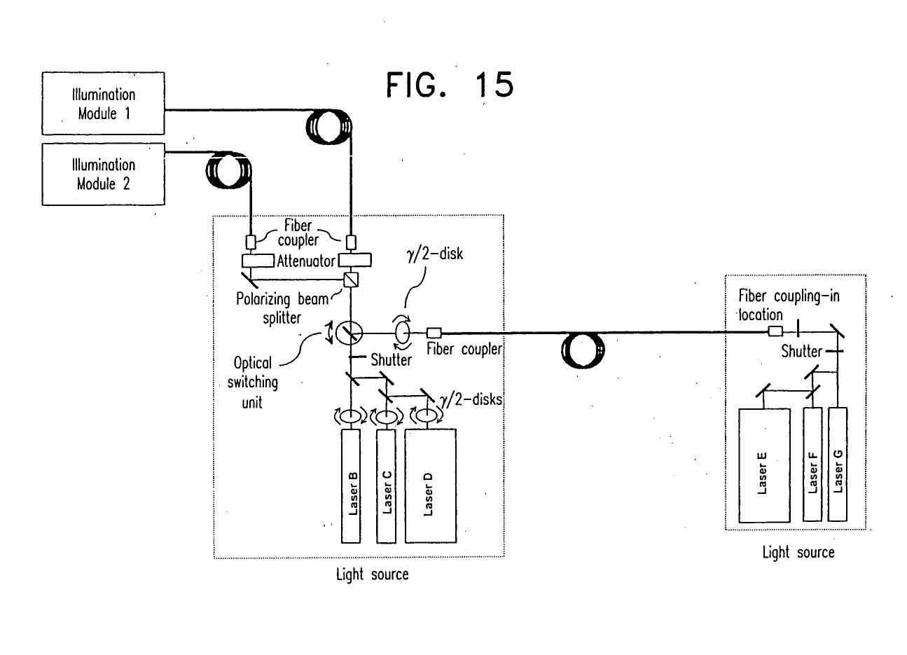

In FIG. 13, an RT scanner and a point-scanning LSM are envisioned, which are both able to execute pictures of the sample in the same or different sample areas using a shared beam condenser.

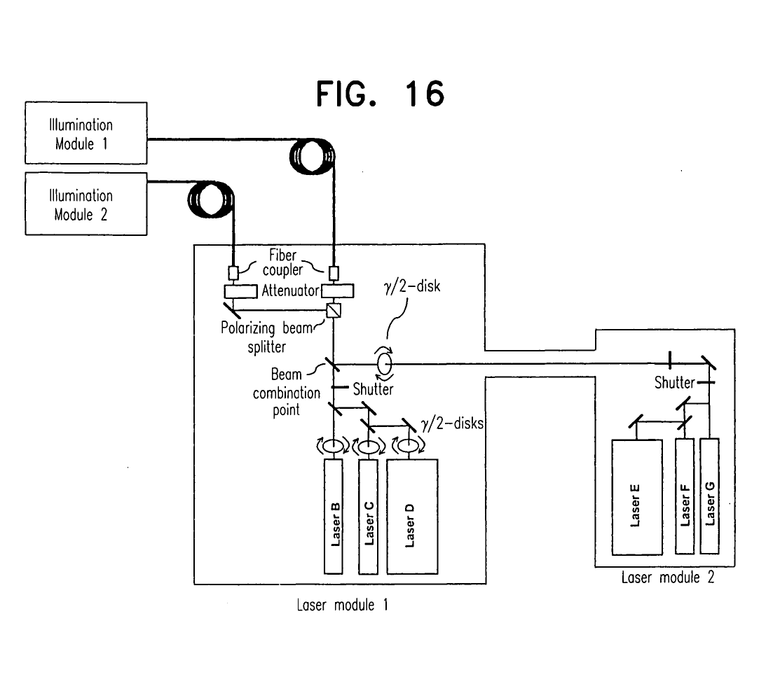

A variety of laser modules, B-D, A, G-E are envisioned, each of which, as described above, can be adjusted upon demand to be available to both systems. In FIG. 14 an RT scanner and a manipulator are coupled into the microscope portion either in alternating fashion or according to preference through use of a switching unit (sliding mirror) which switches between a beam path coupled in from the bottom and one from the side.

A shared light source module is effective for both systems, as described above.

FIG. 15 illustrates that an adjustable coupling of light sources 1 and 2 into one shared beam path, each source preferably consisting in each case of multiple lasers, is accomplished by way of example via a fast SS switchable mirror. The polarization of the lasers can be at least partially influenced by λ/2 plates placed after them. Only after first passing the optical fiber, the light from light source 2 is also allowed to pass a λ/2 plate. In this way, it is possible to influence the amount of light contributed by light source 2 before it is coupled into the shared beam path.

A pole splitter located in the common beam path serves to again partition the light into the different illumination modules 1 and 2, to different scanner configurations for image acquisition and/or manipulation, whereby the light portions and intensities which reach the individual illumination modules can be controlled according to individual preference. This control is again exercised by means of λ/2 plates and the beam attenuator (AOTF) placed within the now separate beam paths.

III. 16 represents a design form similar to FIG. 15 in which the light of a laser module 2 is guided into a combined beam, but without the use of optical fibers. In this case, by way of example, a channel within the housing is used.

The invention herein described represents a significant expansion of the possible applications of fast confocal microscopes. The significance of a development of this type can inferred from the standard literature of cell biology and the descriptions it contains of fast cellular and subcellular processes¹, as well as from the methods used for investigation of a multitude of dyes². See, for example: ¹B. Alberts et al. (2002): Molecular Biology of the Cell; Garland Science ^{1,2}G. Karp (2002) Cell and Molecular Biology: Concepts and Experiments; Wiley Textbooks ^{1,2}R. Yuste et al. (2000): Imaging neurons—a laboratory Manual; Cold Spring Harbor Laboratory Press, New York. ²R. P. Haugland (2003): Handbook of fluorescent Probes and research Products, 10th Edition, Molecular Probes Inc. and Molecular Probes Europe BV.

The invention is of particular significance for the following processes and procedures:

Development of Organisms

The invention described is suitable, among other things, for the investigation of developmental processes which are above all characterized by dynamic processes ranging in duration from a tenth of a second to a number of hours. Potential applications at the cell group and whole organism level of are given here, for example:
Abdul-Karim, M. A. et al. describe 2003 in Microvasc. Res., 66:113-125 analysis of blood vessel changes in living animals over an extended period of time, in which fluorescence images were taken at intervals of several days. The 3-D data sets were evaluated using adaptive algorithms, in order to schematically illustrate the trajectories of movement.
Soll, D. R. et al. describe 2003 in Scientific World Journ. 3:827-841 a software-based analysis of the movement of nuclei and pseudopods in living cells in all 3 spatial dimensions using microscopic data.
Grossman, R. et al. describe 2002 in Glia, 37:229-240 a 3D analysis of the movement of microglia cells of rats, in which data were recorded over a period of up to 10 hours. At the same time, following traumatic damage the glia demonstrate unusually fast reactions, leading to a high data flow and correspondingly high data volume. This is particularly relevant with respect to the following points: Analysis of living cells in a 3D environment, where the neighboring cells are very sensitive to laser light and must be shielded from the light of the 3D-ROI;
Analysis of living cells in a 3D environment using markers which have to be subjected to targeted bleaching with laser light, e.g. FRET experiments;
Analysis of living cells in a 3D environment using markers which must be subjected to targeted bleaching with laser light and simultaneously require observation outside of the ROI; e.g. FRAP- and FLIP experiments in 3D;
Targeted analysis of living cells in 3D using markers and pharmaceuticals which exhibit manipulation-dependant changes as a result of exposure to laser light, for example, activation of transmitters in 3D; Targeted analysis of living cells in a 3D environment using markers which exhibit manipulation-dependent color changes resulting from exposure to laser light, e.g. paGFP, Kaede;
Targeted analysis of living cells in a 3D environment using very faint markers, i.e. markers which require striking an optimal balance between confocality and detection sensitivity;
Living cells in a 3D tissue matrix with varying multiple markers, e.g. CFP, GFP, YFP, DsRed, HcRed among others;
Living cells in a 3D tissue matrix using markers which exhibit function-dependent color changes, e.g. Ca+ markers.
Living cells in a 3D tissue matrix using markers which exhibit development-dependent color changes, e.g. transgenic animals with GFP.
Living cells in a 3D tissue matrix using markers which exhibit manipulation-dependent color changes through laser light, e.g. paGFP, Kaede
Living cells in a 3D tissue matrix using very faint markers which require limiting the confocality in order to increase detection sensitivity.

Last point mentioned above in combination with the one previous to it.

Transport Processes Within Cells

The invention described is excellently suited for the examination of transport processes within cells, as it requires resolution of extremely small, motile structures, e.g. proteins, having very high speeds. In capture the dynamics of complex transport processes, applications such as FRAP with ROI bleaching are often employed. Examples for these kinds of studies are described here, e.g.:
Umenishi, F. et al. describe 2000 in Biophys. J., 78:1024-1035 an analysis of the spatial motility of aquaporin in GFP-transfixed culture cells. In this connection, specific locations in the cell membrane were bleached and the fluorescence diffusion in the surrounding area was analyzed.

Gimpl, G. et al. describe 2002 in Prog. Brain Res., 139:43-55 experiments with ROI-bleaching and fluorescence imaging for analysis of the mobility and distribution of GFP-marked oxytocin receptors in fibroblasts. High demands are placed here upon the spatial positioning and resolution of bleaching and imaging, as well as their direct chronological consequences.

Zhang et al. describe 2001 in Neuron, 31:261-275 live cell imaging of GFP-transfixed nerve cells, in which the movement of granuli was analyzed through combined bleaching and fluorescence imaging. The dynamic of nerve cells places high demands on imaging speed in this case.

Molecular Reciprocal Processes

The invention described is particularly suited to the depiction of molecular and other subcellular reciprocal processes. In these cases, very small, high-velocity structures (within the range of hundredths of a second) must be imaged. In order to resolve the spatial position which the molecule must occupy in order for the reciprocal process to take place, indirect technologies e.g. FRET with ROI-bleaching can also be used. Example applications are described here, e.g.:
Petersen, M. A. and Dailey, M. E. describe 2004 in Glia, 46: 195-206 two channel imaging of living hippocampus cultures from rats, in which the two channels for the markers Lectin and Sytox were recorded spatially in 3D and over an extended period of time.
Yamamoto, N. et al. describe 2003 in Clin. Exp. Metastasis, 20:633-638 a two-color imaging of human fibro sarcoma cells, in which green and red fluorescent proteins (GFP and RFP) were simultaneously observed in real time.
Bertera, S. et al. describe 2003 in Biotechniques, 35: 718-722 a multicolor imaging of transgenic mice marked with timer reporter protein, which changes its color from green to red following synthesis. The image acquisition takes the form of a fast 3-dimensional series in the tissue of the living animal.
   Signal Transfer Between Cells

The invention described is extremely well-suited to the investigation of signal transferal processes, which take place for the most part with extreme rapidity. These mainly neurophysiological processes place the highest possible demands on time-dependent resolution, because the activities, which are mediated by ions, occur in a time frame ranging from hundredths to less than a few thousandths of a second. Example applications of investigations upon the muscular and nervous system are described here, e.g.:
Brum G et al describe 2000 in J. Physiol. 528: 419-433 the localization of rapid Ca+ activities in frog muscle cells following stimulation, with caffeine as a transmitter. The localization and micrometer-exact resolution could only be achieved by employing a fast confocal microscope.
Schmidt H. et al. describe 2003 in J. Physiol. 551:13-32 an analysis of Ca+ ions in nerve cell processes of transgenic mice. The investigation of rapid Ca+-transients in mice with altered Ca+-binding proteins could only be carried out using a high-resolution confocal microscope, because the localization of Ca+ activity within the nerve cell and the exact chronology of its kinetics also plays an important role.

1-25. (canceled)

26. Raster scanning light microscope comprising:
means for punctiform light source distribution,
at least one illumination module generating laser light,
means for variably partitioning the laser light into at least two illumination channels, and
means for illuminating a single sample using the at least two illumination channels jointly, at the same or in different areas of the sample.

27. Raster scanning light microscope according to claim 26, wherein the means for illuminating causes the at least two illumination channels to jointly illuminate the sample simultaneously or in alternating fashion.

28. Raster scanning light microscope according to claim 26, wherein the illuminating module includes at least one laser.

29. Raster scanning light microscope according to claim 26, further including means for adjusting at least one of the intensity, wavelength, and polarization of the partitioned illumination.

30. Raster scanning light microscope according to claim 26, wherein the illumination module includes multiple lasers of varying wavelength.

31. Raster scanning light microscope according to claim 30, further comprising means for combining the multiple lasers into a single shared beam path, the means for variably partitioning the laser light being positioned in the single shared beam path.

32. Raster scanning light microscope according to claim 26, wherein the illumination module includes an adjustable laser, and wherein the means for variably partitioning the laser light partitions the light from the adjustable laser into at least two channels.

33. Raster scanning light microscope according to claim 26, further comprising means for combining at least one additional laser before the means for variably partitioning the laser light.

34. Raster scanning light microscope according to claim 26, further comprising means for adjusting at least one of the intensity and wavelength of the laser light.

35. Raster scanning light microscope according to claim 26, further comprising means for connection one of the partitioned illumination channels with at least one of one additional raster scanning light microscope and an optical manipulation unit.

36. Raster scanning light microscope according to claim 35, wherein the additional raster scanning light microscope is a line scanner.

37. A raster scanning microscope array comprising:
a primary raster scanning light microscope,
at least one of at least one secondary raster scanning light microscope and an optical manipulation unit, and
means for optically partitioning the illumination light from at least one of the primary raster scanning light microscope, the at least one secondary raster scanning light microscope, and the manipulation unit,
wherein the primary raster scanning light microscope, the at least one secondary raster scanning light microscope and the optical manipulation unit illuminate a sample in at least one of simultaneous and alternating fashion, and
wherein one of the primary and secondary raster scanning microscopes illuminates at least one of the other of the primary and secondary raster scanning microscopes and the manipulation unit, respectively.

38. Microscope array according to claim 37, further comprising optical fibers optically connecting the primary raster scanning light microscope, the at least one secondary raster scanning light microscope, and the manipulation unit.

39. Microscope array according to claim 37, in which at least one joint illumination module is envisioned for multiple independent systems which illuminate the sample using raster scanning.

40. Raster scanning light microscope according to claim 35, wherein the means for variably partitioning the laser light are acoustooptical.

41. Raster scanning light microscope according to claim 35, wherein the means for variably partitioning the laser light are diffractive.

42. Raster scanning light microscope according to claim 35, wherein the means for variably partitioning the laser light are involve optical polarization.

43. Raster scanning light microscope according to claim 35, wherein the means for variably partitioning the laser light include bean splitting mirrors.

44. Raster scanning light microscope according to claim 35, wherein the means for variably partitioning the laser light include swinging mirrors.

45. Raster scanning light microscope according to claim 35, wherein the means for variably partitioning the laser light are adjustable with respect to at least one of intensity and wavelength.

46. Raster scanning light microscope according to claim 35, wherein the means for variably partitioning the laser light include rapid switching devices.

47. Method for studying developmental processes, comprising the step of:
analyzing dynamic processes lasting from tenths of a second up to several hours, at the cell group and entire organism level, using the raster scanning microscope array according to claim 37.

48. Method for studying transport processes within cells, comprising the step of:
imaging of small motile structures having high velocities, using the raster scanning microscope array according to claim 37.

49. Method for depicting molecular and other subcellular reciprocal processes, comprising the step of:
depicting very small, high-velocity structures for the resolution of submolecular structures, using the raster scanning microscope array according to claim 37.

50. Method for studying fast signal transfer processes, comprising the step of:
studying neurophysiological processes with high rates of resolution, in particular for investigations of muscular or nervous systems, using the raster scanning microscope array according to claim 37.
